(19) United States
(12) Patent Application Publication
(10) Pub. No.: US 2007/0246449 A1
(43) Pub. Date: Oct. 25, 2007

(54) GUTTER SYSTEM WITH INTEGRAL SNOW AND ICE MELTING CABLE

(76) Inventor: James E. Bachman, Omaha, NE (US)

Correspondence Address: HOVEY WILLIAMS LLP, 2405 GRAND BLVD., SUITE 400, KANSAS CITY, MO, 64108, US

(21) Appl. No.: 11/380,024

(22) Filed: Apr. 25, 2006

(51) Int. Cl. H05B 3/00

(52) U.S. Cl. 219/213

(57) ABSTRACT

A gutter system with integral snow and ice melting cable which more effectively and efficiently prevents the formation of snow and ice dams. The gutter system comprises an elongated gutter, a gutter cover, and a pair of heating elements. The gutter cover presents a longitudinal axis and includes a rear wall adapted to be affixed to the building, a front wall spaced from the rear wall, and a bottom wall extending between a lower edge of the rear wall and a lower edge of the front wall. The gutter cover substantially covers an open end of the gutter and includes a first panel adapted to be placed over or under roofing material on the roof, a second panel attached to the first panel and adapted to overlie the open end of the gutter, and a water channel attached to the second panel for directing water into the gutter. The heating elements are positioned on a top surface of the bottom wall of the gutter and extend generally parallel to one another and parallel to the longitudinal axis of the gutter for melting snow and ice which accumulates on the gutter cover without requiring heating elements to be positioned on the gutter cover itself. A first one of the heating elements is positioned adjacent the front wall of the gutter and a second one of the heating elements is positioned slightly inboard of the first heating element so that both heating elements are closer to the front wall of the gutter than the rear wall to concentrate heat below the water channel of the gutter cover.

### BACKGROUND OF THE INVENTION

1. Field of the Invention

The present invention relates to gutters and gutter covers. More particularly, the invention relates to a gutter system including a gutter, a gutter cover, and a pair of heating elements positioned and configured to melt snow and ice from the gutter cover without requiring excessive lengths of the heating elements and without requiring attachment of the heating cables to the gutter cover.

2. Description of the Prior Art

Gutters are often installed on houses and other buildings to collect and carry water away from roofs and other sloped surfaces. The gutters and roofs are unfortunately subject to the accumulation of snow and ice in colder climates. Accumulated snow and ice can cause “ice dams” which interfere with the normal shedding and collection of water. Ice dams can also damage the roofs and gutters. As water backs up behind an ice dam, it can flow through small cracks in the roof or spaces between the roof and the gutter. Over time, the freezing and subsequent thawing cycle of the water expands these cracks, eventually damaging the roof and underlying materials. Ice and snow which accumulates on a gutter can also slowly pull the gutter away from the building, leaving gaps between the gutter and the building. Water can then run through these gaps rather than being carried away from the building by the gutter and thus cause damage to the building. Ice dams also often break away and fall to the ground, potentially causing injury to persons and damage to property below.

Heating cables and other de-icing products can be placed on roofs, gutter covers, and/or gutters to prevent the accumulation of snow and ice and the resultant formation of ice dams. For example, it is common to place a heating cable in a snake or sinusoidal pattern in the bottom of a gutter to melt snow and ice which accumulates in the gutter. Unfortunately, installing heating cable in this fashion is wasteful and inefficient because an excessive length of cable is typically used. Moreover, the heating cable tends to bunch up or otherwise move over time, creating hot spots with too much cable and cold spots with not enough cable. To avoid the cold spots, installers often use even more cable, thus exasperating the inefficiencies mentioned above, or install additional cable on top of a gutter cover placed over the gutter. The use of additional heating cable is even more wasteful and creates an impediment to the normal flow of water over the gutter cover. Heating cable on top of a gutter cover also traps leaves and other debris, further impeding the normal flow of water over the gutter cover.

### SUMMARY OF THE INVENTION

The present invention solves the above-described problems and provides a distinct advance in the art of gutters and gutter covers. More particularly, the present invention provides a gutter system which more effectively and efficiently prevents the formation of ice dams in gutters and on gutter covers.

One embodiment of the gutter system comprises an elongated gutter adapted to be affixed to a building and a pair of heating elements positioned and configured to melt snow and ice from the gutter and a corresponding gutter cover without the use of additional heating cables on the gutter cover itself. The gutter presents a longitudinal axis and includes a rear wall for attachment to the building, a front wall spaced from the rear wall, and a bottom wall extending between the lower edges of the rear and front walls. The heating elements are positioned on a top surface of the bottom wall and extend generally parallel to one another and parallel to the longitudinal axis of the gutter for melting snow and ice which accumulates on the gutter cover without requiring excessive lengths of the heating elements and without requiring the heating elements to be positioned on the gutter cover itself.

Another embodiment of the gutter system comprises an elongated gutter, a gutter cover, and a pair of heating elements. The gutter cover presents a longitudinal axis and includes a rear wall adapted to be affixed to the building, a front wall spaced from the rear wall, and a bottom wall extending between a lower edge of the rear wall and a lower edge of the front wall. The gutter cover substantially covers an open end of the gutter and includes a first panel adapted to be placed over or under roofing material on the roof, a second panel attached to the first panel and adapted to overlie the open end of the gutter, and a water channel attached to the second panel for directing water into the gutter. The heating elements are positioned on a top surface of the bottom wall of the gutter and extend generally parallel to one another and parallel to the longitudinal axis of the gutter for melting snow and ice which accumulates on the gutter cover without requiring excessive lengths of the heating elements and without requiring the heating elements to be positioned on the gutter cover itself. A first one of the heating elements is positioned adjacent the front wall of the gutter and a second one of the heating elements is positioned slightly inboard of the first heating element so that both heating elements are closer to the front wall of the gutter than the rear wall to concentrate heat below the water channel of the gutter cover.

These and other important aspects of the present invention are described more fully in the detailed description below.

### BRIEF DESCRIPTION OF THE DRAWING FIGURES

Preferred embodiments of the present invention are described in detail below with reference to the attached drawing figures, wherein:

FIG. 1 is a fragmentary perspective view of a gutter system constructed in accordance with a preferred embodiment of the present invention and shown affixed below a roof of a building.

FIG. 2 is another fragmentary perspective view of the gutter system of FIG. 1 shown with the gutter cover removed.

FIG. 3 is a fragmentary perspective view of a gutter system constructed in accordance with another preferred embodiment of the present invention and shown affixed below a roof of a building.

FIG. 4 is a fragmentary perspective view of a gutter system constructed in accordance with another preferred embodiment of the invention.

FIG. 5 is a fragmentary perspective view of a gutter system constructed in accordance with another preferred embodiment of the invention and shown with the gutter cover removed.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

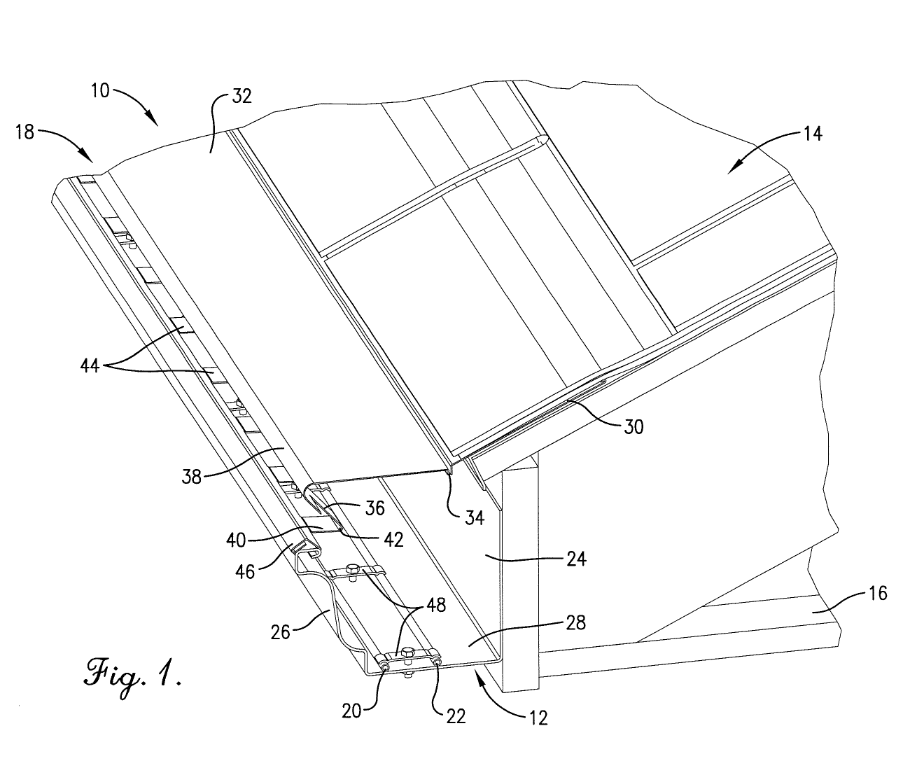

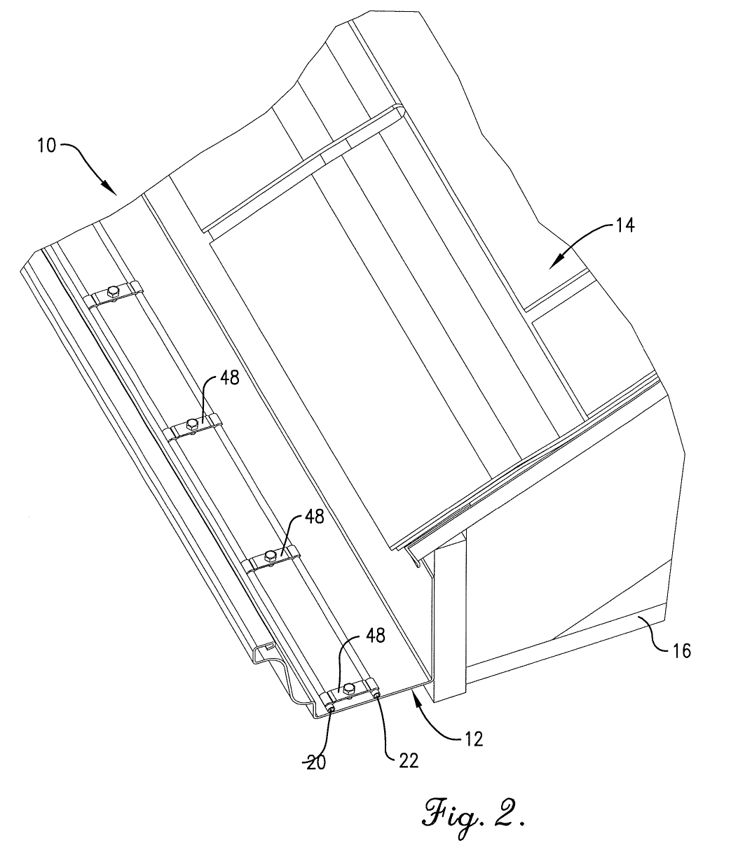

Turning now to the drawing figures, and particularly FIGS. 1 and 2, a gutter system 10 constructed in accordance with a first preferred embodiment of the invention is illustrated. The gutter system 10 broadly includes an elongated gutter 12 adapted to be attached below a roof 14 or other sloped surface of a building 16; a gutter cover 18 for at least partially covering an open end of the gutter; and a pair of heating elements 20, 22 positioned in the gutter for melting snow and ice which accumulates on the gutter cover. As discussed in more detail below, the heating elements are sized, positioned and configured to melt snow and ice from the gutter cover without requiring excessive and inefficient amounts of the heating elements and without requiring attachment of the heating elements to the gutter cover itself.

The particular gutter 12 shown and illustrated herein is provided for purposes of disclosing a preferred embodiment of the present invention. Many aspects of the gutter 12, such as its size and construction material, may be selected as a matter of design choice. For example, the gutter may be formed of any suitable material such as aluminum, vinyl, galvanized steel, stainless steel, or copper and may be sectional or seamless. The gutter may have a K-shape, U-shape, or any other profile and may be of any diameter, such as 4, 5, or 6 inches. The gutter 12 may be attached to the building 16 by hangers or other conventional fasteners, may include a number of downspouts for carrying water to the ground or other collection area, and may be used with conventional elbows, end caps, and leader pipes.

The gutter 12 broadly includes a rear wall 24 for attachment to the building 16, a front wall 26 spaced from the rear wall 24 and a bottom wall 28 extending between lower edges of the rear wall and the front wall. The rear 24, front 26, and bottom 28 walls define a water-carrying channel for collecting water which runs off the roof and for carrying the water to the ground, a sewer system, or other collection point via the downspouts.

The bottom wall 28 may include a pair of elongated grooves or slots for receiving and retaining the heating elements 20, 22 as disclosed in co-pending application entitled “Snow and Ice Resistant Gutter System”, Ser. No. 11/089,401, filed on Mar. 24, 2005, hereby incorporated into the present application by reference. However, the heating elements 20, 22 are preferably positioned on top of the bottom wall 28 of the gutter as described below so that no grooves or slots are required.

The gutter cover 18 is installed over the gutter 12 so as to collect water from the roof 14 and to direct it into the gutter while preventing leaves and other debris from entering the gutter 12. The gutter cover 18 may be of various shapes and sizes to fit over different sizes and styles of gutters. Several examplary gutter covers are described in detail in U.S. Pat. Nos. 5,557,891; 5,660,001; and 6,098,344, all incorporated into the present application by reference. These patents also disclose in more detail end caps and diverter elements which may be used with the gutter system.

The gutter cover 18 may include a number of individual segments which can be interconnected to cover any length of gutter. In one embodiment, each segment is approximately four feet long and includes one end which can slide into an end of an adjacent segment so a plurality of segments can be interconnected to cover a long length of gutter without the use of screws, brackets, or other fasteners joining the segments together. The gutter cover 18 may also be formed of a single segment that is long enough to cover any desired length of gutter.

Each gutter cover segment is preferably formed from a single piece of aluminum or other suitable material which is bent into the configuration shown in the drawing figures. If the gutter cover 18 is formed of aluminum, the preferred thickness of each segment is preferably between 1/32″ and 1/16″.

Each gutter cover segment 18 includes a generally planar first section 30, which is preferably adapted to be installed under a first row of shingles on the roof without the use of nails, screws, staples or other fasteners. The first section 30 slopes downwardly from right to left when viewed from the perspective of FIG. 1 so as to match the pitch of the roof 14. The angle of the first section can be changed as described below to match the slope of the roof or other sloped surface to which it is attached. The rightmost end of the first section when viewed in FIG. 1 includes a lip formed by a generally 180° bend. The lip resists movement of the first section 18 once it is installed under the roof shingles.

Each gutter cover segment also includes a generally planar second section 32 which is adapted to overlie the open end of the gutter 12. The second section slopes gradually from right to left as viewed from FIG. 1 so as to direct water away from the roof, over the left edge of the second section, and into the gutter. The second section 32 may include a number of elongated ridges or bumps (not shown) that run parallel to the longitudinal axis of the gutter to slow the flow of water over the second section.

The first 30 and second 32 sections are joined by a bend 34 that performs several important functions. First, the bend 34 slows the flow of water from the roof to the second section by reversing the direction of water flow through capillary action. Through capillary action, water flowing over the bend 34 follows along the surface of the bend and reverses direction rather than spilling over the bend. Second, the bend 34 permits the angle of the first section 30 to be adjusted relative to the second section 32 so as to match the pitch of the roof 14 to which the gutter cover is attached.

The bend 34 may be generally V-shaped or U-shaped in cross section as disclosed in co-pending application Ser. No. 11/384,136, entitled “GutterCover”; filed Mar. 17, 2006, or may be generally S-shaped in cross section as disclosed in the above referenced U.S. patents. The co-pending application Ser. No. 11/384,136 is hereby incorporated into the present application by reference.

Each gutter cover segment 18 also includes a generally planar third section 36 joined to the second section 32 by a bend 38. The bend 38 preferably has an obtuse angle so that the third section 36 slopes downwardly and inwardly relative to the leftmost edge of the second section 32. As with the bend 34, the bend 38 and the third section 36 serve to reverse and slow the flow of water over the gutter cover through capillary action.

Each gutter cover segment 18 also includes a water channel formed in part by a generally planar fourth section 40 joined to the third section 36 by a bend 42. The bend 42 preferably has an acute angle that, when summed with the angle of the bend 38, equals approximately 180°, so that the fourth section 40 is generally parallel with the second section 32. That is, the fourth section 40 has a slight downward slope from right to left when viewed from FIG. 1. For example, the bend may have an angle of approximately 120° and the bend may have an angle of approximately 60°.

As best illustrated in FIG. 1, a series of spaced-apart holes or cutouts 44 are formed in the fourth section 40 to direct water flowing over the second section 32 and the bend 38 into the underlying gutter 12. Similar holes or cutouts may be formed elsewhere in the gutter cover to direct water into the underlying gutter. For example, holes may be formed in or near the bend 34 or anywhere along the length of the second section 32.

Each gutter cover segment also includes a leftmost lip or hem section 46 joined to the left edge of the fourth section 40. The lip 46 may be connected to the front upper edge of the gutter by mounting brackets or other fasteners.

The heating elements 20, 22 themselves are conventional and are operable to emit heat when connected to a suitable source of electricity. An example of a heating element that may be used with the present invention is the Tuff brand heating cable manufactured and sold by Heatizon Systems of Salt Lake City, Utah. The heating cables are connected to a suitable transformer and control box, such as those provided by Heatizon, to provide low-voltage electricity. The control box may also include or be connected to an activation device, such as those provided by Heatizon, to control when electricity is delivered to the heating cable (for example, only during cold days).

In accordance with one important aspect of the present invention, the heating elements 20, 22 are sized, positioned and configured to prevent accumulation of snow and ice on the gutter cover without requiring excessive and inefficient lengths of cable and without requiring attachment of the heating cables to the gutter cover 18 itself.

As best illustrated in FIG. 1, the heating elements are preferably heating cables positioned on a top surface of the bottom wall 28 of the gutter so that most of the surface areas of the cables are above the bottom wall 28. This convects most of the heat from the cables up to the bottom surface of the gutter cover 18 rather than allowing the heat to conduct into the bottom wall 28 of the gutter 12. This permits the use of fewer heating cables than would be required if the cables were flush-mounted with the bottom wall of the gutter cover. The preferred heating cables are 8 watt, 10 gauge coated copper cables that are weather and chemical resistant. Applicant has discovered that 8 watt cables, instead of more common 5 watt cables, are necessary to achieve the desired heating of the gutter cover.

As best illustrated in FIG. 2, the heating cables 20, 22 extend parallel to one another and parallel to the longitudinal axis of the gutter. Applicant has discovered that using two straight runs of heating cable as illustrated require approximately 50% less cable than using a single run of cable that is installed in a snake or sinusoidal pattern (the exact difference in length is of course dependent on the particular sinusoidal pattern).

The heating cables 20, 22 are preferably positioned closer to the front wall 26 of the gutter than the rear wall 24 to direct heat to the portion of the gutter cover which is spaced furthest from the building. This is important because the portions of the gutter cover and gutter furthest from the building receive the least amount of heat from the building. In the embodiment of FIG. 1, the heating cable 20 is positioned approximately ⅛″ to 1″ from the front wall 26 and the heating cable 22 is positioned approximately ⅛″ to 1″ from the heating cable 20. This positions both of the heating cables near the openings 44 in the gutter cover water channel to prevent snow and ice from blocking the openings. The heating cables are ideally positioned so that the heating cable 20 is approximately ½″ from the front wall 26 and the heating cable 22 is approximately ½″ inboard of the heating cable 20. Applicant has discovered that positioning the two heating cables in this fashion heats the water channel to over 12° F. above the ambient temperature when using 8 watt cables. This prevents the formation of snow and ice dams on the gutter cover 18 in most climates. For extremely cold climates, higher wattage cables may be used or an additional heating cable can be installed between or on either side of the heating cables.

The heating cables are preferably held in place on the bottom wall of the gutter by a plurality of spaced clips 48. The clips 48 shown in FIGS. 1 and 2 are secured to the bottom wall of the gutter with screws, bolts, or other fasteners and can be spaced anywhere between 1″ to 8″ apart. The clips 48 shown in the drawing figures are merely examples of clips that may be used and may be replaced with other styles of clips without departing from the scope of the present invention.

By sizing, positioning, and configuring the heating elements 20, 22 as described herein, numerous advantages are realized. For example, the present invention is more efficient because less heating cable is required, saving both installation and operational costs. Additionally, the present invention eliminates the need for heating cables on the gutter cover itself, thus further increasing its efficiency and eliminating any blockage of water and debris on the gutter covers. Moreover, the present invention prevents the formation of ice and snow dams with relatively low wattage heating cables, further saving energy costs.

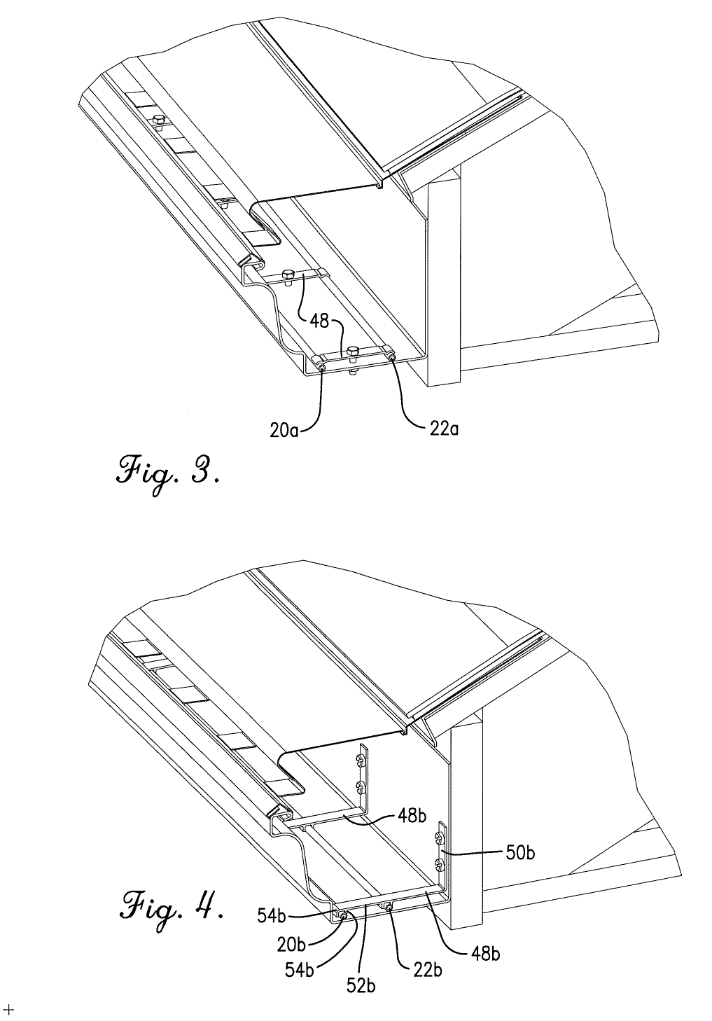

FIG. 3 illustrates a second embodiment of the invention which is similar to the first embodiment except that the heating cables 20a, 22a are spaced further from one another. Specifically, in this embodiment, the heating cable 20a is positioned between ⅛″ to 1″ from the front wall of the gutter and the heating cable 22a is positioned between ⅛″ and 1″ from the rear wall. This configuration is more suitable for geographic areas which don't experience extremely cold winters because less heat is concentrated below the water channel.

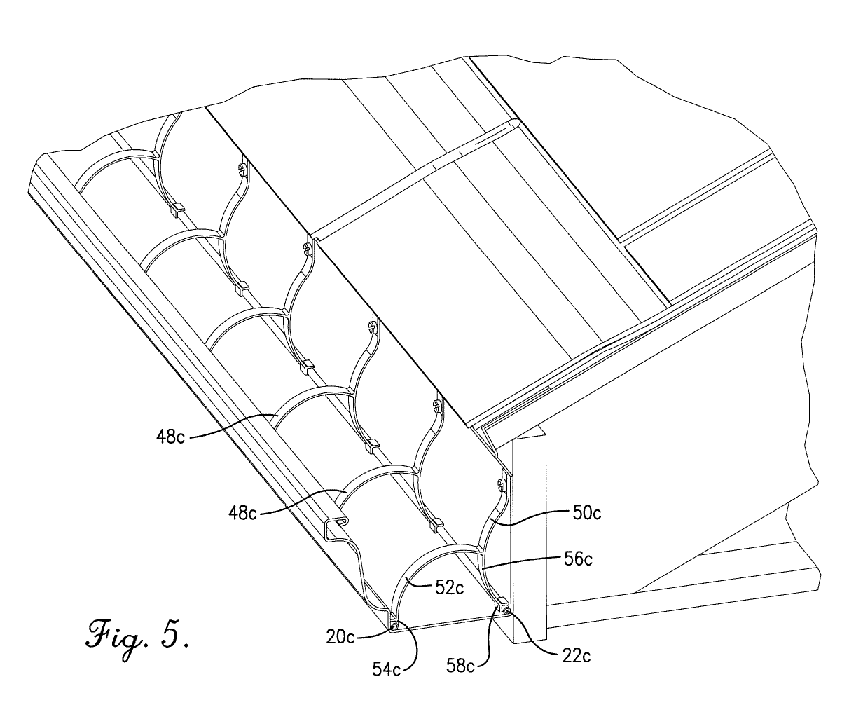

FIG. 4 illustrates a third embodiment of the invention which is similar to the first embodiment except that a different clip 48b is used to secure the heating cables to the gutter. In this embodiment, the clip 48b includes a vertical leg 50b which is screwed or otherwise fastened to the fascia of the building through the rear wall of the gutter. A horizontal leg 52c with spaced-apart depending tabs 54c hold the heating cables 20b, 22b against the bottom wall of the gutter. This clip design does not create holes in the bottom of the gutter and is therefore preferred to the clip design of FIGS. 1 and 2.

FIG. 5 illustrates a fourth embodiment of the invention which includes yet another clip design. The clip 48c is generally h-shaped and includes an upper, slightly bowed leg 50c which is screwed or otherwise fastened to the fascia of the building through the rear wall of the gutter. A curved leg 52c with a pair of orthogonal tabs 54c holds the cable 20c against the front wall of the gutter and a slightly bowed leg 56c with a pair of orthogonal tabs 58c holds the cable 22c against the rear wall of the gutter. This clip design is preferred because it does not obstruct the flow of water through the gutter as much as the clips of FIGS. 1-4.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A gutter system comprising:
an elongated gutter adapted to be affixed to a building, the gutter including a rear wall for attachment to the building, a front wall spaced from the rear wall, and a bottom wall extending between the lower edges of the rear and front walls, the gutter presenting a longitudinal axis; and
a pair of heating elements positioned on a top surface of the bottom wall and extending generally parallel to one another and parallel to the longitudinal axis of the gutter for melting snow and ice which accumulates in or on the gutter or on a gutter cover which covers the gutter.

2. The gutter system as set forth in claim 1, further including at least one clip for securing the heating elements to the bottom wall of the gutter and for maintaining the generally parallel orientation of the heating elements to one another and to the longitudinal axis of the gutter.

3. The gutter system as set forth in claim 1, wherein the heating elements are heating cables.

4. The gutter system as set forth in claim 1, wherein a first one of the heating elements is positioned adjacent the front wall of the gutter and a second one of the heating elements is positioned slightly inboard of the first heating element so that both heating elements are closer to the front wall of the gutter than the rear wall to concentrate heat in a portion of the gutter furthest from the building.

5. The gutter system as set forth in claim 1, wherein a first one of the heating elements is positioned adjacent the front wall of the gutter and a second one of the heating elements is positioned adjacent the rear wall of the gutter so that the heating elements evenly distribute heat within the gutter.

6. The gutter system as set forth in claim 1, wherein the heating elements are 8 watt heating cables.

7. A gutter system for attachment to a building for carrying water from a roof of the building, the gutter system comprising:
an elongated gutter presenting a longitudinal axis and including-
a rear wall adapted to be affixed to the building;
a front wall spaced from the rear wall;
a bottom wall extending between a lower edge of the rear wall and a lower edge of the front wall;
a gutter cover for substantially covering an open end of the gutter, the gutter cover including-
a first panel adapted to be placed over or under roofing material on the roof;
a second panel attached to the first panel and adapted to overlie the open end of the gutter;
a water channel attached to the second panel for directing water into the gutter; and
a pair of heating elements positioned on a top surface of the bottom wall of the gutter and extending generally parallel to one another and parallel to the longitudinal axis of the gutter for melting snow and ice which accumulates on the gutter cover without requiring heating elements to be positioned on the gutter cover.

8. The gutter system as set forth in claim 7, further including a plurality of clips for securing the heating elements to the bottom wall of the gutter and for maintaining the generally parallel orientation of the heating elements to one another and to the longitudinal axis of the gutter.

9. The gutter system as set forth in claim 7, wherein the heating elements are heating cables.

10. The gutter system as set forth in claim 7, wherein a first one of the heating elements is positioned adjacent the front wall of the gutter and a second one of the heating elements is positioned slightly inboard of the first heating element so that both heating elements are closer to the front wall of the gutter than the rear wall to concentrate heat below the water channel of the gutter cover.

11. The gutter system as set forth in claim 7, wherein a first one of the heating elements is positioned adjacent the front wall of the gutter and a second one of the heating elements is positioned adjacent the rear wall of the gutter so that the heating elements evenly distribute heat within the gutter.

12. The gutter system as set forth in claim 7, wherein the heating elements are 8 watt heating cables.

13. A gutter cover system for at least partially covering a gutter attached to a building having a roof, the gutter cover system compromising:
a gutter cover for substantially covering an open end of the gutter, the gutter cover including-
a first panel adapted to be placed over or under roofing material on the roof;
a second panel attached to the first panel and adapted to overlie an open end of the gutter;
a water channel attached to the second panel for directing water into the gutter; and
a pair of heating elements for positioning on a top surface of a bottom wall of the gutter and extending generally parallel to one another and parallel to a longitudinal axis of the gutter for melting snow and ice which accumulates on the gutter cover without requiring heating elements to be positioned on the gutter cover.

14. The gutter system as set forth in claim 13, further including a plurality of clips for securing the heating elements to the bottom wall of the gutter and for maintaining the generally parallel orientation of the heating elements to one another.

15. The gutter system as set forth in claim 13, wherein the heating elements are heating cables.

16. The gutter system as set forth in claim 13, wherein a first one of the heating elements is positioned adjacent the front wall of the gutter and a second one of the heating elements is positioned slightly inboard of the first heating element so that both heating elements are closer to the front wall of the gutter than the rear wall to concentrate heat below the water channel of the gutter cover.

17. The gutter system as set forth in claim 13, wherein a first one of the heating elements is positioned adjacent a front wall of the gutter and a second one of the heating elements is positioned adjacent a rear wall of the gutter so that the heating elements evenly distribute heat within the gutter.

18. The gutter system as set forth in claim 13, wherein the heating elements are 8 watt heating cables.
